(19) United States
(12) Patent Application Publication
(10) Pub. No.: US 2008/0206628 A1
(43) Pub. Date: Aug. 28, 2008

(54) LITHIUM SECONDARY BATTERY

(76) Inventor: Hidetoshi Honbou, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/018,581

(22) Filed: Jan. 23, 2008

(30) Foreign Application Priority Data
Feb. 28, 2007 (JP) 2007-048350

(51) Int. Cl. H01M 4/02

(52) U.S. Cl. 429/94

(57) ABSTRACT

There is disclosed a lithium secondary battery which is high in output characteristics and excellent in long-life properties. This battery comprises electrodes-wound bodies each constructed such that a lithium storable/releasable positive electrode and a lithium storable/releasable negative electrode are wound together with an electrolyte and a separator being interposed between these electrodes. The electrodes-wound bodies are electrically connected in parallel by making use of a collector to form a group of electrodes and the group of electrodes is housed in a square battery case.

### BACKGROUND OF THE INVENTION

1. Field of the Invention

This invention relates to a lithium secondary battery.

2. Description of the Related Art

Since the lithium secondary battery is characterized by high energy density and high output density, it is widely employed in recent years as a power source for personal computers and mobile instruments. Further, many efforts are now being made for the development of a motorcar which is environmentally friendly such as an electric motorcar and a hybrid motorcar, wherein it is studied to apply the lithium secondary battery to the power source of motorcars. There are a number of important problems to solve in the employment of the lithium secondary battery for use in the electric motorcar and the hybrid motorcar, the problems including high output, high energy density and extension of life.

JP Published Patent Application No. 2005-327527 discloses a square type lithium ion secondary battery which is constructed such that a negative electrode, a separator and a positive electrode are wound into a flattened structure, which is subsequently press-molded and housed in a square battery case. Although the square type lithium ion secondary battery constructed in this manner is now widely employed in a mobile telephone, etc., there is a problem if such a lithium ion secondary battery is to be applied to a large scale battery which can be used in the electric motorcar and the hybrid motorcar, since it is difficult to sufficiently increase the clamping pressure at a central portion of the aforementioned flattened wound body, resulting in the swelling of battery and in the shortened life of battery.

Further, JP Published Patent Application No. 2003-533844 discloses a structure of battery module wherein cylindrical cells are arrayed therein. This structure however is accompanied with a problem that since the ratio of space occupied by the parts such as the battery case, etc. in the battery module is caused to increase, resulting in the deterioration of weight-energy density.

### BRIEF SUMMARY OF THE INVENTION

An object of the present invention is to provide a lithium secondary battery which is high in output characteristics and excellent in long-life properties.

The lithium secondary battery according to the present invention is featured in that it comprises electrodes-wound bodies each constructed such that a lithium storable/releasable positive electrode and a lithium storable/releasable negative electrode are wound together with an electrolyte and a separator being interposed between these electrodes, and that the electrodes-wound bodies are electrically connected in parallel by making use of a collector to form a group of electrodes and this group of electrodes is housed in a battery case.

The lithium secondary battery according to the present invention is also featured in that a diameter in cross-section perpendicular to the longitudinal axis of each of the electrodes-wound bodies is confined to the range of 15 mm-25 mm.

The lithium secondary battery according to the present invention is also featured in that a length of longitudinal axis of each of the electrodes-wound bodies is confined to the range of 100 mm-150 mm.

The lithium secondary battery according to the present invention is also featured in that the electrodes-wound bodies are juxtaposed to form a group of electrodes and that the positive and negative electrodes are respectively provided with a plurality of collector tabs which are respectively electrically connected with the collector plate.

According to the present invention, it is possible to provide a lithium secondary battery, which is high in output characteristics and excellent in long-life properties.

### BRIEF DESCRIPTION OF THE SEVERAL VIEWS OF THE DRAWING

FIG. 1 shows a lithium secondary battery according to one embodiment of the present invention;

FIG. 2 shows a lithium secondary battery according to one comparative example;

FIG. 3 is a perspective view illustrating the electrodes-wound body of lithium secondary battery according to the present invention;

FIG. 4 shows a group of electrodes of the lithium secondary battery according to the present invention;

FIG. 5 shows a group of electrodes of the lithium secondary battery according to the present invention;

FIG. 6 is a perspective view illustrating the process of manufacturing a group of electrodes of the lithium secondary battery according to the present invention;

FIG. 7 is a side view illustrating the process of manufacturing a group of electrodes of the lithium secondary battery according to the present invention;

FIG. 8 shows a group of electrodes of the lithium secondary battery according to the present invention;

FIG. 9 shows a lithium secondary battery module according to the present invention;

FIG. 10 shows a lithium secondary battery module according to the present invention;

FIG. 11 shows a lithium secondary battery pack according to the present invention;

FIG. 12 is a graph illustrating a ratio of rise in resistance of the batteries of Example 1 and Comparative Example 1; and

FIG. 13 is a diagram illustrating the electrodes-wound body of lithium secondary battery according to the present invention.

### DETAILED DESCRIPTION OF THE INVENTION

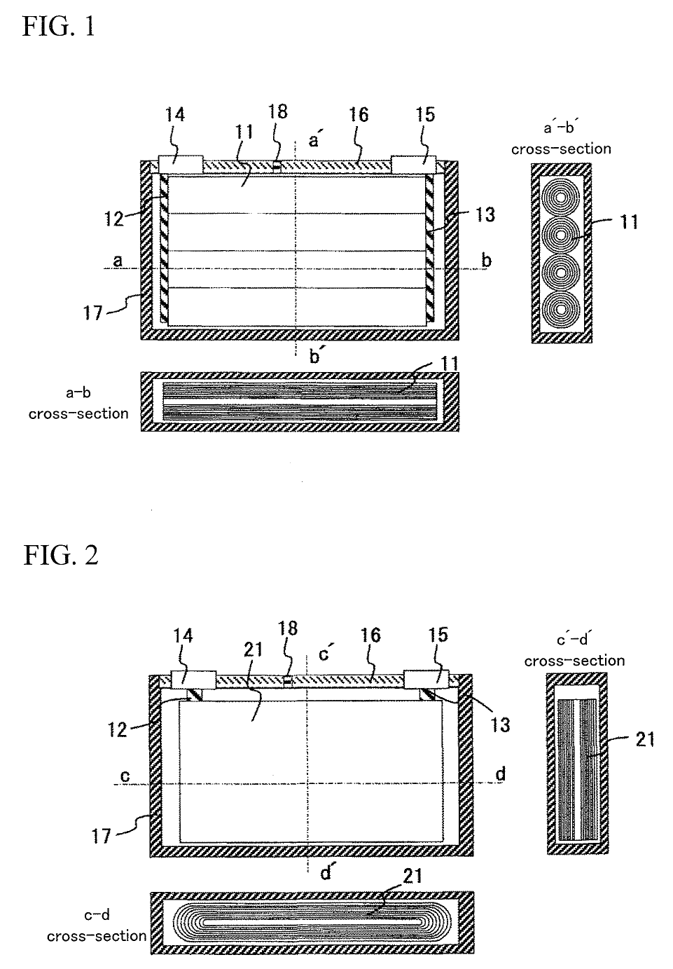

FIG. 1 schematically illustrates a square type lithium secondary battery according to one embodiment of the present invention, and FIG. 2 shows a square type lithium secondary battery according to the prior art.

According to the square type lithium secondary battery of the prior art, a flattened wound body 21 is housed in a battery case 17.

This conventional square battery is accompanied with a problem that a central portion of the flattened wound body tends to easily swell, so that in the case of the negative electrode for instance, the active material thereof is caused to fall from a copper foil constituting an electrode substrate, thus giving rise to the lowering of output and capacity.

Whereas in the case of the electrodes-wound bodies of square type lithium secondary battery according to the present invention, since the configuration thereof is cylindrical and clamping pressure applied thereto is uniform, the falling of active material can be minimized and hence the life of battery would be increased. Further, since the electrodes are partitioned into a plurality of wound bodies, the number of collecting points can be increased and the internal resistance of battery can be reduced, resulting in an enhancement in output of battery.

By the way, in the case of the lithium secondary battery of the present invention, a group of electrodes where a plurality of cylindrical electrode-wound bodies 11, each constituted by a wound body of a positive electrode, a negative electrode and a separator, are arrayed in a row is housed horizontally in a square battery case 17. There is also provided with a battery cap 16 equipped with a positive terminal 14 and a negative terminal 15. These terminals 14 and 15 are electrically insulated from the battery cap 16. The positive electrodes of the electrodes-wound bodies are respectively electrically connected in parallel with to a positive collector plate 12 and the negative electrodes of the electrodes-wound bodies are respectively electrically connected in parallel with to a negative collector plate. Further, the positive collector plate 12 is electrically connected with the positive terminal and the negative collector plate is electrically connected with the negative terminal. The battery case is hermetically sealed by the battery cap, thus forming the square type lithium secondary battery of the present invention.

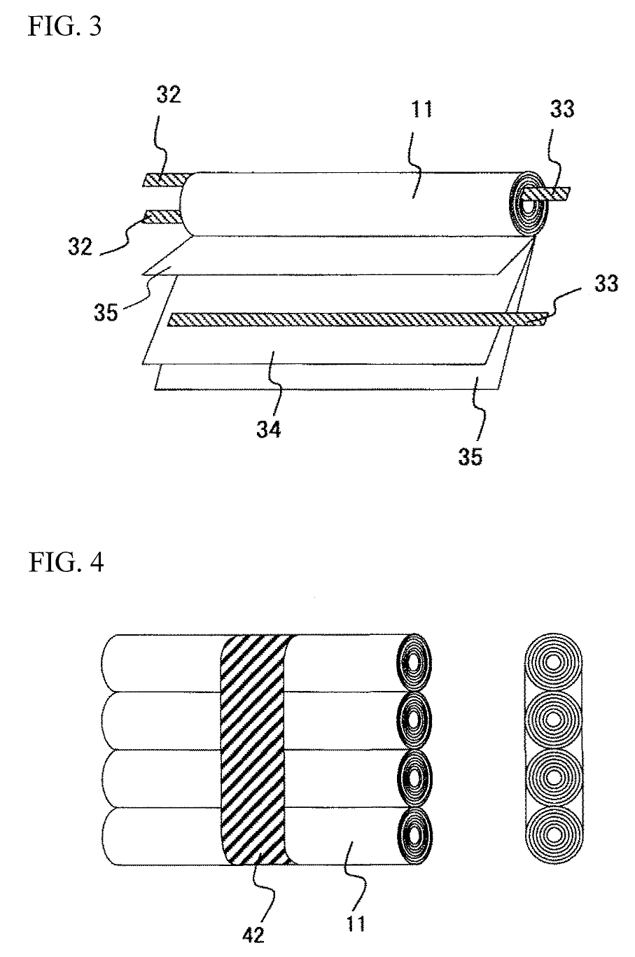

FIG. 3 shows one embodiment of the electrodes-wound body according to the present invention. A negative electrode 34 is electrically connected with a plurality of negative collector tabs 33 which are extended transversely almost all over the entire width of the negative electrode 34. Likewise, a positive electrode is electrically connected with a plurality of positive collector tabs 32 which are extended transversely almost all over the entire width of the positive electrode.

Herein, it is preferable to confine the diameter in cross-section perpendicular to the longitudinal axis of each of the electrodes-wound bodies to the range of 15 mm-25 mm.

If this diameter is smaller than 15 mm, the capacity of battery would become too small, thereby making it unsuitable for use in a hybrid car. On the contrary, if this diameter is larger than 25 mm, the electrode sheet would become too long, thereby increasing the collecting resistance of battery and resulting in the decrease of output of battery.

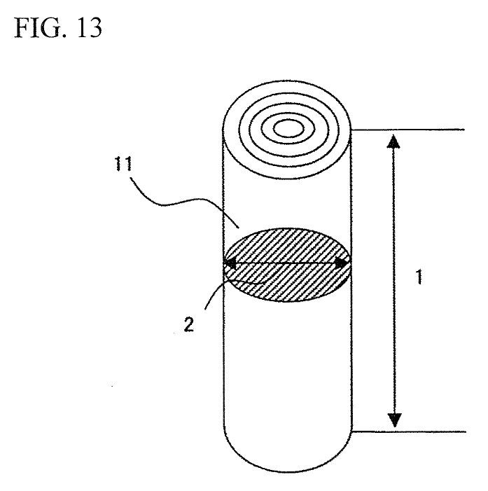

By the way, by the term “longitudinal axis”, it is intended to indicate the longitudinal direction of the cylindrical electrodes-wound body as shown in FIG. 13. Further, when the electrodes-wound body is assumed as being columnar, the line connecting the center of one circular end thereof with the center of the other circular end can be defined as the longitudinal axis.

Further, it is preferable to confine the length of longitudinal axis of each of the electrodes-wound bodies to the range of 100 mm-150 mm. If this longitudinal axis is smaller than 100 mm, the capacity of battery would become too small, thereby making it unsuitable for use in a hybrid car. If this longitudinal axis is larger than 150 mm, a separator having a larger width is required to be used. A separator having a larger width is more liable to sagging or wrinkling. Due to these phenomena, internal short-circuit of battery may be caused to occur or the decrease of voltage may be caused to occur during the storage of battery, thereby deteriorating the reliability of the battery. Therefore, the employment of a separator having a larger width is undesirable.

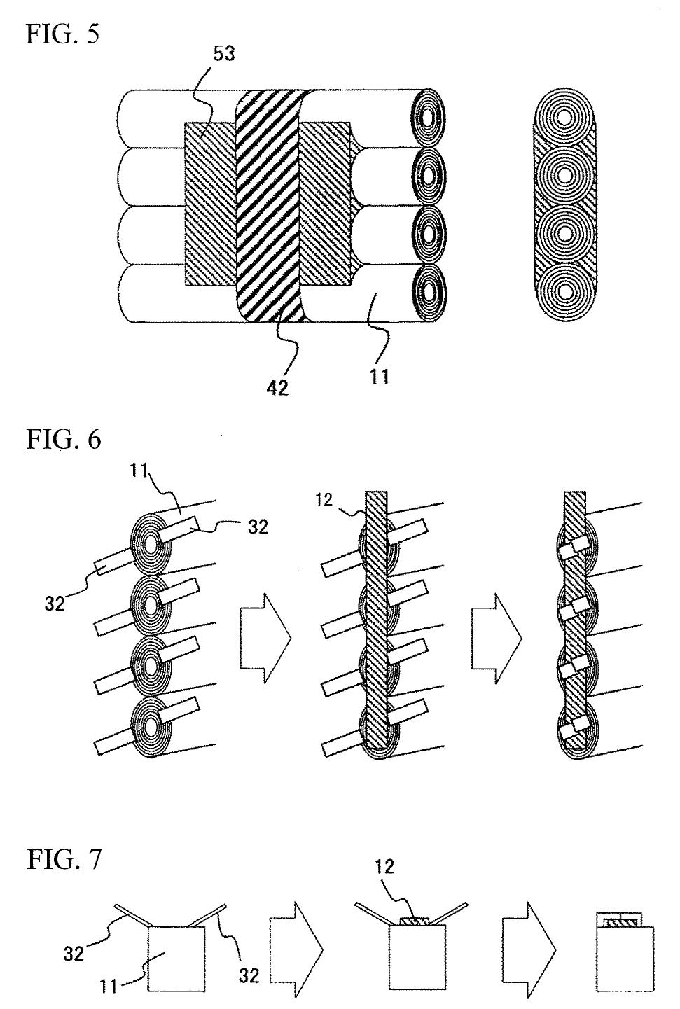

Next, the group of electrodes according to the present invention will be explained as follows. A method of fixing the electrodes-wound bodies shown in FIG. 3 will be explained with reference to FIGS. 4 and 5. The electrodes-wound bodies 11 are fixed together by making use of an adhesive tape made of, for example, polypropylene or polyethylene sulfide, which is resistive to an electrolysis solution. When it is desired to fix these electrodes-wound bodies at higher precision, these electrodes-wound bodies are fixed each other together with a fixing guide 53 by making use of the adhesive tape.

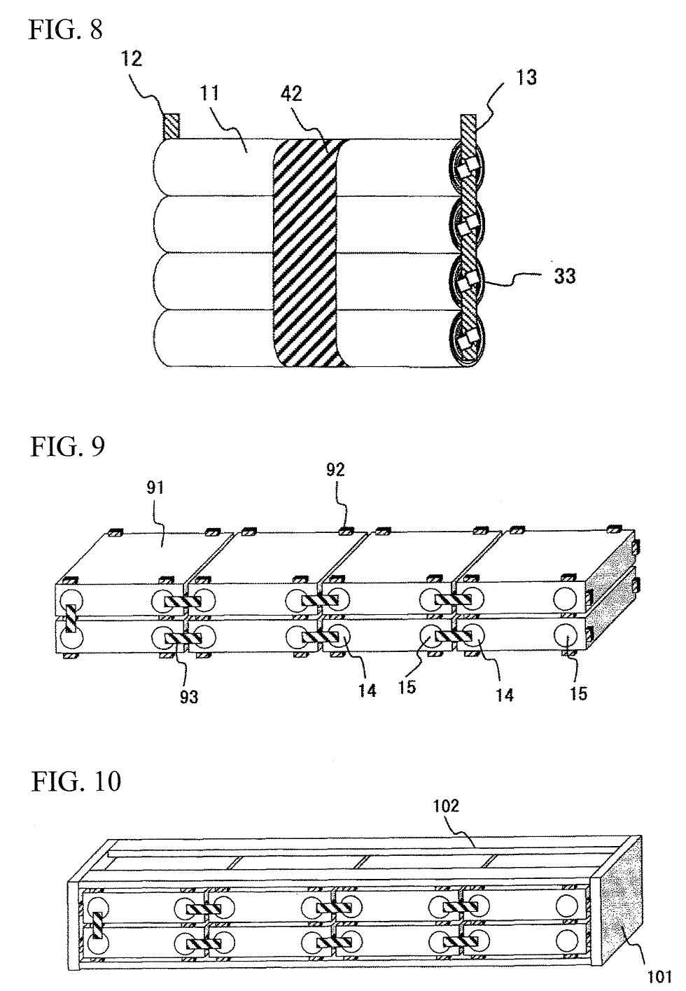

A method of electrically connecting the electrodes-wound bodies with each other will be explained with reference to FIGS. 6, 7 and 8. First of all, the positive collector tabs 32 are expanded outward and then a ribbon-like positive collector plate 12 is disposed in place. Then, the positive collector tabs 32 are respectively turned back inward and welded to the positive collector plate 12, thereby electrically connecting the positive collector tabs 32 to the positive collector plate 12. Likewise, the negative collector tabs 33 can be electrically connected to the negative collector plate in the same manner, thus obtaining the group of electrodes as shown in FIG. 8. As explained above, the electrodes-wound bodies are not housed separately in the battery case but are housed integrally as a group of electrodes, thereby making it possible to decrease the ratio of space that is occupied by the parts such as the battery case, etc. in the battery module. As a result, the weight-energy density of battery can be enhanced.

Moreover, according to the present invention, a plurality of lithium secondary batteries described above are horizontally arrayed and spaced away from each other with a spacer interposed between them, thereby making it possible to obtain a lithium secondary battery module which is capable of easily dissipating the heat to be generated in the charging/discharging.

The positive electrode can be created by coating a positive electrode material onto the surface of a collector body which is made of aluminum. The positive electrode is constituted by an active material contributing to the absorption and desorption of lithium, activated carbon, a conductive material, a binder, etc.

As for the active material for the positive electrode, it is possible to employ a composite compound consisting of lithium and a transition metal and having a crystal structure such as a spinel type cubic system, a layer type hexagonal system, an olivine type rhombic system, a triclinic system, etc. From the viewpoints of high output, high energy density and long life, it is more preferable to employ a layer type hexagonal system comprising, at least, lithium, nickel, manganese and cobalt, most preferably, a composition represented by LiMnₐNi_{b}Co_{c}M_{d}O₂ (wherein M is at least one kind of element selected from the group consisting of Fe, V, Ti, Cu, Al, Sn, Zn, Mg and B, preferably from the group consisting of Fe, V, Al, B and Mg; 0≦a≦0.6; 0.3≦b≦0.6; 0≦c≦0.4; and 0≦d≦0.1). Further, it is preferable that the active material for the positive electrode has an average particle diameter of not larger than 10 μm.

The active material for the positive electrode may be provided as a powdery material having a predetermined composition. The powdery material is ground and mixed by mechanical means such as ball mill. The grinding and mixing of the powdery material may be performed in a dry or wet system. The raw powder thus pulverized should preferably be as fine as not larger than 1 μm in particle diameter, more preferably not larger than 0.3 μm. Furthermore, the raw powder thus pulverized should preferably be spray-dried and then granulated. Thereafter, the powder thus obtained is sintered at a temperature ranging from 850° C. to 1100° C., more preferably from 900° C. to 1050° C. This sintering step may be performed in an oxidizing gas atmosphere such as an oxygen gas atmosphere or an air atmosphere, in an inter gas atmosphere such as a nitrogen gas atmosphere or an argon gas atmosphere or in a mixed gas atmosphere containing these gases.

As for the conductive material, it is possible to employ high-conductivity powdery graphite wherein the length Lc in the direction of c-axis of carbon crystal lattice is not less than 100 nm, scaly graphite, carbon black constituted by amorphous carbon or any combination of these material. As for the mixing ratio of this conductive material, it is preferable to confine it to 3-12% by weight in the case of powdery graphite, 1-7% by weight in the case of scaly graphite, and 0.5-7% by weight in the case of amorphous carbon. If the mixing ratio of powdery graphite is less than 3% by weight, the conductive network inside the positive electrode may become insufficient and if the mixing ratio of powdery graphite is larger than 12% by weight, the quantity of positive electrode material is caused to decrease, resulting in the lowering of capacity of battery. If the mixing ratio of scaly graphite is less than 1% by weight, the effects to be derived from the reduction of conductive material as the scaly graphite is replaced by other kinds of conductive materials would be reduced and the mixing ratio of scaly graphite is larger than 7% by weight, it may bring about an increase of voids in the positive electrode resulting in the lowering in density of positive electrode, since the average particle diameter of scaly graphite is relatively large. If the mixing ratio of amorphous carbon is less than 0.5% by weight, it may become insufficient for linking each other the voids existing among the positive electrode materials and if the mixing ratio of amorphous carbon is larger than 7% by weight, it may bring about a prominent decrease in density of positive electrode.

The negative electrode can be created by coating a negative electrode material onto the surface of a collector body which is made of copper. The negative electrode is constituted by an active material contributing to the absorption and desorption of lithium, a conductive material, a binder, etc.

As for the active material for the negative electrode, it is possible to employ, for example, metal lithium, carbon material and a material which is capable of absorbing lithium or of forming a lithium compound. Among them, carbon material is especially preferable. As for the carbon material, it is possible to employ graphite such as natural graphite, artificial graphite, etc.; and amorphous carbon such as coal cokes, carbides of coal pitch, petroleum cokes, carbides of petroleum pitch and carbides of pitch cokes.

Preferably, these carbon materials should desirably be variously surface-treated. These carbon materials can be employed singly or in combination of two or more kinds. As for the material which is capable of absorbing lithium or of forming a lithium compound, it is possible to employ metals such as aluminum, tin, silicon, indium, gallium, magnesium, etc.; alloys containing any of these elements; and metal oxides containing tin, silicon, etc. Further, it is also possible to employ a composite material constituted by any of aforementioned metals, alloys and metal oxides and by any of graphitic carbon material and amorphous carbon materials.

It is preferable that the material for the negative electrode has an average particle diameter of not larger than 20 μm.

With respect to the conductive material and binder, there is not any particular limitation.

The manufacture of the electrodes of the present invention can be performed as follows for instance.

First of all, a slurry is formed by mixing each other an active material for positive electrode, powdery graphite as a conductive material, a carbonaceous material selected from scaly graphite, amorphous graphite and a combination thereof, and a binder such as poly(vinylidene fluoride) (PVDF). On this occasion, in order to enable the active material, the activated carbon and the conductive material to be uniformly dispersed in the slurry, it is preferable to perform sufficient mixing of these materials by making use of a kneader. Then, by making use of, for example, a roll transfer type coater, the slurry thus obtained is coated on the opposite surfaces of aluminum foil having a thickness ranging from 15 to 25 μm. After finishing this coating process, the coated layers are press-dried to obtain a positive electrode plate. As for the thickness of the composite material portion formed of a mixture of the active material for positive electrode, the activated carbon, the conductive material and the binder, it is preferable to confine it to 20-100 μm.

The negative electrode plate can be manufactured in the same manner as in the case of the positive electrode plate, wherein an active material, etc. are mixed with a binder to obtain a mixture, which is then coated and pressed to form a negative electrode plate. As for the thickness of the composite material for the electrode, it is preferable to confine it to 20-70 μm. In the case of negative electrode, a copper foil having a thickness of 7-20 μm is employed as a collector body. As for the mixing ratio of the components of slurry, for example, the mixing ratio between the negative electrode materials and the binder, it is preferable to confine it to 90:10 based on weight.

As for the electrolysis solution, it is preferable to employ those comprising an electrolyte such as lithium phosphate hexafluoride (LiPF₆), lithium borate tetrafluoride (LiBF₄), lithium perchlorate (LiClO₄), etc., which is dissolved in a solvent such as diethyl carbonate (DEC), dimethyl carbonate (DMC), ethylene carbonate (EC), propylene carbonate (PC), vinylene carbonate (VC), methyl acetate (MA), ethylmethyl carbonate (EMC), methylpropyl carbonate (MPC), etc. The concentration of the electrolyte should preferably be confined to the range of 0.7-1.5M. The electrolysis solution is then introduced into the battery case to thereby accomplish a lithium secondary battery.

Next, although specific examples of the present invention will be explained in detail, these examples are not intended to limit the scope of the present invention.

### EXAMPLE 1

### Preparation of Positive Electrode

In this example, nickel oxide, manganese oxide and cobalt oxide were employed raw materials and weighed to obtain a mixture comprising these materials at an atomic ratio of: Ni:Mn:Co=1:1:1. Then, this mixture was pulverized and mixed together by means of a wet type pulverizer. Subsequently, polyvinyl alcohol (PVA) was added as a binder to this pulverized mixture and then granulated by making use of a spray dryer.

The resultant granulate was placed in a high-purity alumina vessel and provisionally sintered for 12 hours at a temperature of 600° C. to thereby evaporate PVA. Thereafter, this sintered body was air-cooled and then cracked. Further, to this cracked power was added lithium hydroxide monohydrate at such an amount as to make the atomic ratio between Li and transitional metals (Ni, Mn, Co) become 1.1:1. The resultant mixture was then sufficiently intermingled. The mixed powder thus obtained was placed in a high-purity alumina vessel and finally sintered for 6 hours at a temperature of 900° C. The active material for positive electrode thus obtained was cracked and classified. An average particle diameter of this active material for positive electrode was 6 μm.

Then, the active material for positive electrode, three kinds of conductive materials including powdery graphite, scaly graphite and amorphous carbon, and PVDF were mixed together to obtain a mixture comprising these materials at a weight ratio of: 85:7:2:2:4. To this mixture was added a suitable quantity of N-methyl-2-pyrrolidone to prepare a slurry. This slurry was stirred for three hours by means of a planetary mixer, thereby sufficiently kneading it. Thereafter, by making use of a roll transfer type coater, the slurry thus obtained was coated on one surface of aluminum foil having a thickness of 20 μm. Then, the opposite surface of aluminum foil was also coated with this slurry in the same manner as described above to prepare a positive electrode sheet. The positive electrode sheet thus prepared was allowed to dry at a temperature of 120° C. and then pressed at a pressure of 250 kg/mm by means of a roll press. On this occasion, the density of the composite material for positive electrode was 2.4 g/cm³.

### Preparation of Negative Electrode

For the purpose of preparing a negative electrode, 6.5% by weight of carbon black was added as a conductive material to amorphous carbon having an average particle diameter of 10 μm to obtain a mixture, which was then stirred for 30 minutes by making use of a planetary mixer, thereby sufficiently kneading it. Thereafter, by making use of a coater, the slurry thus obtained was coated on the opposite surfaces of copper foil having a thickness of 10 μm. The coated layer was then allowed to dry and pressed by means of a roll press to obtain a negative electrode sheet wherein the density of the composite material for negative electrode was 1.0 g/cm³.

### Preparation of Square Type Battery

The positive electrode sheet and the negative electrode sheet were respectively cut out to a predetermined size. Then, a collector tab was attached respectively to an uncoated portion of both end portions of electrode by means of ultrasonic welding. The collector tab for the positive electrode was made from aluminum and the collector tab for the negative electrode was made from nickel. A porous polyethylene film was interposed between the positive electrode and the negative electrode and the resultant composite body was wound into a cylindrical configuration. Thereafter, four in number of this electrode-wound body were fixedly arrayed in a row by making use of polypropylene adhesive tape as shown in FIG. 4.

Further, by following the procedures as shown in FIGS. 6 and 7, the positive electrode collector tabs were welded to a positive collector plate made of aluminum and the negative electrode collector tabs were welded to a negative collector plate made of nickel, thereby obtaining a group of electrodes as shown in FIG. 8.

As shown in FIG. 1, the aforementioned group of electrodes was housed in an aluminum battery case and the positive collector plate was welded to the positive terminal. On the other hand, the negative collector plate was welded to the negative terminal and then a battery cap was attached to the battery case. Finally, an electrolysis solution was introduced into the battery case via an inlet port provided in the battery cap. Thereafter, the inlet port was closed and hermetically sealed. As for the electrolysis solution, an organic electrolysis solution (nonaqueous electrolysis solution) comprising a mixture of EC, DMC and EMC (1:1:1 in volume ratio) and LiPF₆ which was dissolved in the mixture at a ratio of 1 mol/L was employed.

### Pulse Charge/Discharge Test

By making use of the square type lithium secondary battery, a pulse charge/discharge test was performed under the following conditions.

(1) Central voltage of charge/discharge: 3.6V

(2) Discharge pulse: Electric current 12CA (0.083 hour rate current), the time being set to 30 seconds.

(3) Charge pulse: Electric current 6CA (0.167 hour rate current), the time being set to 15 seconds.

(4) Pause time between discharging and charging: set to 30 seconds.

(5) Due to the fluctuation of the central voltage, constant voltage charging or constant voltage discharging was performed every 1000 pulses at 3.6V and the central voltage was adjusted to 3.6V.

(6) Temperature of environmental atmosphere was set to 50° C.

Further, the DC resistance and output density of battery were determined according to the following method. Under the environment of 50° C., the discharging of 10 seconds was performed in the order of electric current of: 4CA, 8CA, 12CA and 16CA.

The relationship between the discharging current on this occasion and the voltage at the end of 10 seconds was plotted and the direct current resistance was determined from the inclination of the plotted line thus obtained. Further, the value of current at 2.5V in the plotted line was determined and then the product of 2.5V and this value of current was divided by the weight of battery to determine the output density. FIG. 12 shows a ratio of rise in resistance of the battery that resulted from the pulse cycle wherein the initial resistance was assumed as being 100.

### COMPARATIVE EXAMPLE 1

A positive electrode sheet and a negative electrode sheet were manufactured in the same manner as described in Example 1. Then, the positive electrode sheet and the negative electrode sheet were respectively cut out to a predetermined size. Then, a collector tab was attached respectively to an uncoated portion of both end portions of electrode by means of ultrasonic welding. The collector tab for the positive electrode was made from aluminum and the collector tab for the negative electrode was made from nickel. A porous polyethylene film was interposed between the positive electrode and the negative electrode and the resultant composite body was wound into a flattened configuration.

Then, this flattened electrodes-wound body was housed in an aluminum battery case and the positive collector tabs were welded to the positive terminal. On the other hand, the negative collector tabs were welded to the negative terminal and then a battery cap was attached to the battery case. Finally, an electrolysis solution was introduced into the battery case via an inlet port provided in the battery cap. Thereafter, the inlet port was closed and hermetically sealed. As for the electrolysis solution, an organic electrolysis solution (nonaqueous electrolysis solution) comprising a mixture of EC, DMC and EMC (1:1:1 in volume ratio) and LiPF₆ which was dissolved in the mixture at a ratio of 1 mol/L was employed.

Further, the pulse charge/discharge test of the battery was performed in the same manner as in Example 1 to measure the DC resistance of the battery. FIG. 12 shows a ratio of rise in resistance of the battery that resulted from the pulse cycle wherein the initial resistance was assumed as being 100.

### EXAMPLE 2

Square type lithium secondary batteries were manufactured in the same manner as described in Example 1 except that the diameter in cross-section perpendicular to the longitudinal axis of each of the electrodes-wound bodies was variously changed to 10 mm, 15 mm, 20 mm, 25 mm and 30 mm. The capacity and output density of each of the square type lithium secondary batteries are shown in Table 1.

When the diameter in cross-section perpendicular to the longitudinal axis of each of the electrodes-wound bodies was made smaller than 15 mm, the capacity of battery was found too small to apply it to a hybrid car. On the other hand, when the diameter in cross-section perpendicular to the longitudinal axis of each of the electrodes-wound bodies was made larger than 25 mm, the DC resistance was increased, resulting in the lowering of output density of battery and finding it undesirable. From these results thus obtained, it will be recognized that an optimal value of the diameter in cross-section perpendicular to the longitudinal axis of each of the electrodes-wound bodies is confined to the range of 15 mm to 25 mm.

TABLE 1

| Diameter of | Battery | |
|---|---|---|
| electrodes-wound body | capacity | Output density |
| (mm) | (Ah) | (W/kg) |
| 10 | 1.1 | 3100 |
| 15 | 3.2 | 3100 |
| 20 | 3.8 | 3050 |
| 25 | 4.5 | 3050 |
| 30 | 6.8 | 2800 |

### EXAMPLE 3

Square type lithium secondary batteries were manufactured in the same manner as described in Example 1 except that the length of longitudinal axis of each of the electrodes-wound bodies was variously changed to 70 mm, 100 mm, 120 mm, 150 mm and 180 mm. The capacity, output density and voltage drop ratio in long-term storage of each of the square type lithium secondary batteries are shown in Table 2.

By the way, the voltage drop ratio represents a value calculated relative to the initial voltage as the battery was initially fully charged and then stored for one month at a temperature of 60° C. When the length of longitudinal axis of each of the electrodes-wound bodies was made smaller than 100 mm, the capacity of battery was found too small to apply it to a hybrid car. On the other hand, when the length of longitudinal axis of each of the electrodes-wound bodies was made larger than 150 mm, the voltage drop ratio after the long-term storage was increased, finding it undesirable in terms of reliability of battery. From these results thus obtained, it will be recognized that an optimal value of the length of longitudinal axis of each of the electrodes-wound bodies is confined to the range of 100 mm to 150 mm.

TABLE 2

| Length of electrodes- | Battery capacity | Output density | Voltage drop |
|---|---|---|---|
| wound body (mm) | (Ah) | (W/kg) | ratio (%) |
| 50 | 1.6 | 3100 | 80 |
| 100 | 3.2 | 3100 | 82 |
| 120 | 3.9 | 3080 | 79 |
| 150 | 4.5 | 3080 | 78 |
| 180 | 5.8 | 3080 | 65 |

### EXAMPLE 4

By making use of the square type lithium secondary battery which was manufactured in Example 1, a lithium secondary battery module was manufactured. The lithium secondary batteries of the present invention were arrayed in such a manner that two sets of the lithium secondary batteries, each set constituted by four lithium secondary batteries of the present invention which were arrayed in series, were superimposed one another, wherein a spacer 92 was interposed between the batteries to provide a space for heat dissipation. The positive terminal 14 of each of the batteries and the negative terminal 15 of each of the batteries were electrically connected with each other in series by welding a connecting fitting 93 to these terminals. Further, by making use of a clamping plate 102, an end plate 101 was fixed to the battery module, thereby obtaining a lithium secondary battery module.

### EXAMPLE 5

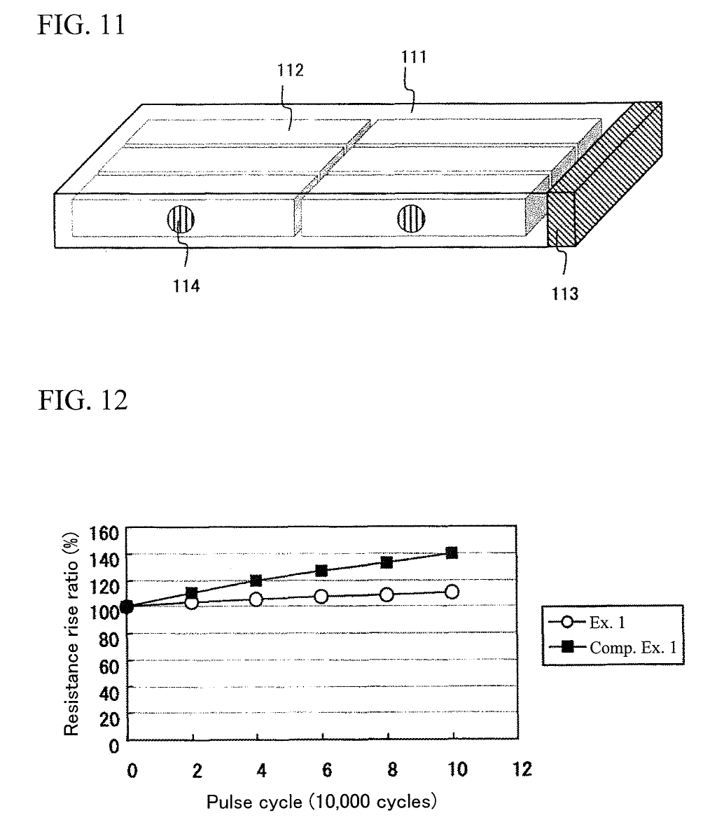

By making use of the lithium secondary battery module which was manufactured in Example 4, a battery pack was manufactured as shown in FIG. 11. A plurality of the lithium secondary battery modules each constructed as shown in FIG. 4 were arrayed in such a manner that two sets of the lithium secondary battery modules, each set constituted by three lithium secondary battery modules which were arrayed in parallel, were arrayed in a row and electrically connected one another in series. The resultant composite body was housed in an outer case 111, thereby manufacturing a thin-type battery pack. To this battery pack were attached a control circuit member 113 for monitoring and controlling the state of charge/discharge, and a fan 114 or a heat dissipating mechanism for cooling the battery pack. Since this battery pack is of thin type, it can be disposed on the bottom of floor of an electric motorcar or of a hybrid car and hence this battery pack is quite suited for securing a sufficient internal space of vehicle.

What is claimed is:

1. A lithium secondary battery comprising electrodes-wound bodies each constructed such that a lithium storable/releasable positive electrode and a lithium storable/releasable negative electrode are wound together with an electrolyte and a separator being interposed between these electrodes;
wherein the electrodes-wound bodies are electrically connected in parallel by making use of a collector to form a group of electrodes and the group of electrodes is housed in a battery case.

2. The lithium secondary battery according to claim 1, wherein a diameter in cross-section perpendicular to the longitudinal axis of each of the electrodes-wound bodies is confined to the range of 15 mm-25 mm.

3. The lithium secondary battery according to claim 1, wherein a length of longitudinal axis of each of the electrodes-wound bodies is confined to the range of 100 mm-150 mm.

4. A lithium secondary battery comprising electrodes-wound bodies each constructed such that a lithium storable/releasable positive electrode and a lithium storable/releasable negative electrode are wound together with an electrolyte and a separator being interposed between these electrodes;
wherein the electrodes-wound bodies are juxtaposed to form a group of electrodes;
the positive and negative electrodes are respectively provided with a plurality of collector tabs; and
the collector tabs are respectively electrically connected with a collector plate.

5. A lithium secondary battery module comprising a plurality of the lithium secondary batteries each constructed as defined by claim 1, which are horizontally arrayed and spaced away from each other with a spacer interposed between them.

6. A lithium secondary battery pack comprising a plurality of the lithium secondary battery modules each constructed as defined by claim 5; a control circuit for controlling at least the state of charge/discharge; and a heat radiation mechanism.

7. A lithium secondary battery comprising electrodes-wound bodies each constructed such that a lithium storable/releasable positive electrode and a lithium storable/releasable negative electrode are wound together with an electrolyte and a separator being interposed between these electrodes;
wherein the electrodes-wound bodies are electrically connected in parallel by making use of a collector; and
a diameter in cross-section perpendicular to the longitudinal axis of each of the electrodes-wound bodies is confined to the range of 15 mm-25 mm.
